(19) United States
(12) Patent Application Publication
(10) Pub. No.: US 2007/0092790 A1
(43) Pub. Date: Apr. 26, 2007

(54) Portable electronic device

(75) Inventor: Liang Chang, Shanghai City (CN)

Correspondence Address: BIRCH STEWART KOLASCH & BIRCH, PO BOX 747, FALLS CHURCH, VA, 22040-0747, US

(73) Assignee: Inventec Appliances Corp., Taipei (TW)

(21) Appl. No.: 11/546,321

(22) Filed: Oct. 12, 2006

(30) Foreign Application Priority Data
Oct. 13, 2005 (TW) 094217725

(51) Int. Cl. H01M 2/10

(52) U.S. Cl. 429/96; 429/98

(57) ABSTRACT

A portable electronic device is disclosed and comprises a body having a cell trough, wherein the sidewall of the cell trough has at least one fixing structure for at least one decorating accessory passing through; and a cell combined with the cell trough, wherein an accommodation area is between the cell and the sidewall. The fixing structure and the accommodation area are to fasten the decorating accessory.

### FIELD OF THE INVENTION

The present invention relates to a portable electronic device, more particularly to a portable device with a hanging hole for at least one decorating accessory passing through.

### BACKGROUND OF THE INVENTION

Portable electronic device as Personal Digital Assistant (PDA) or hand-held communication device is a necessity to almost everybody for remote communication. The convenience of such devices brings that everybody may count on them everyday. Generally speaking, for good-looking or easily carrying, the decorating accessories are usually fastened to the portable electronic devices; on the other hand, the usage of the decorating accessory is to let a user hold the portable electronic device very easily; more, the user surrounds the decorating accessory on the wrist in order to prevent falling down and damaging the portable electronic device.

With reference to FIG. 1, which illustrates a schematic view of a back of a hand-held communication device 100 in prior arts. The back includes a hanging hole 102 for a line fixing portion of a decorating accessory 104 passing through, wherein the line fixing portion is female-connected on the body of the hand-held communication device 100 in order to let the decorating accessory 104 be fastened on the back of the hand-held communication device 100.

Although the decorating accessory 104 of the hand-held communication device 100 in FIG. 1 can be fastened on the back of the hand-held communication device 100. With the advanced development to the hand-held communication device, slimmer volume is a tendency; on the contrary, the hanging hole in prior arts occupies larger space to affect other space for other components. As shown in FIG. 1, the hanging hole 102 occupies the space for the antenna so as to affect the design of the hardware and the signal quality.

### SUMMARY OF THE INVENTION

The primary objective of the present invention is to provide a portable electronic device with a hanging hole, which does not occupy the space for other components, therefore the other space of the portable electronic device can be completely used.

To achieve the objective mentioned above, the portable electronic device provided by the present invention comprises a body having a cell trough, wherein the sidewall of the cell trough has at least one fixing structure for at least one decorating accessory passing through; and a cell combined with the cell trough, wherein an accommodation area is between the cell and the sidewall, the fixing structure and the accommodation area are to fix the decorating accessory.

Preferably, the portable electronic device is a PDA or a hand-held communication device.

Preferably, the sidewall of the cell trough of the portable electronic device has two hanging holes, a line fixing portion of the decorating accessory is through the two hanging holes and the accommodation area between the cell and the sidewall, the line fixing portion is then female-connected on the body so as to let the decorating accessory be fastened at the accommodation area.

Preferably, the sidewall of the cell trough of the portable electronic device has a hanging hole, a T-type fixing portion of the decorating accessory is through the hanging hole so as to fasten the T-type fixing portion at the accommodation area between the cell and the sidewall.

Preferably, the T-type fixing portion is made of elastic material.

Preferably, the cell is a rechargeable battery.

To make it easier for our examiner to understand the objective of the invention, its structure, innovative features, and performance, we use several preferred embodiments together with the attached drawings for the detailed description of the invention.

### BRIEF DESCRIPTION OF THE DRAWINGS

The objects, spirits and advantages of the preferred embodiments of the present invention will be readily understood by the accompanying drawings and detailed descriptions, wherein:

FIG. 1 illustrates a schematic view of a back of a hand-held communication device 100 in prior arts;

FIG. 2A illustrates a schematic three-dimensional view of a first preferred embodiment of the present invention;

FIG. 2B illustrates a schematic three-dimensional view of a second preferred embodiment of the present invention; and

FIG. 2C illustrates a schematic three-dimensional view of a third preferred of the present invention.

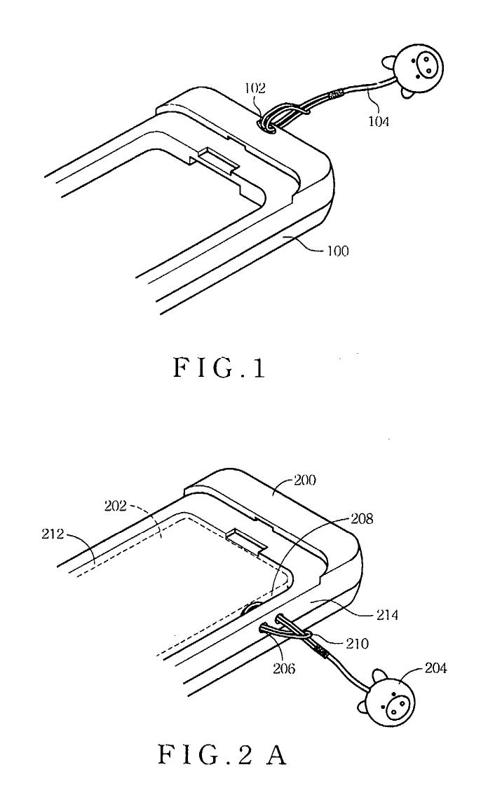

### DETAILED DESCRIPTION OF THE PREFERRED EMBODIMENTS

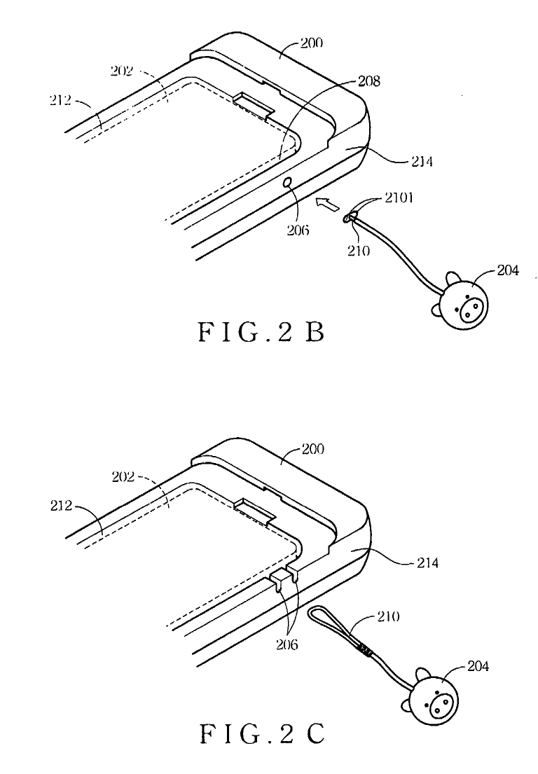

With reference to FIG. 2A, which illustrates a schematic three-dimensional view of a first preferred embodiment of the present invention. The first preferred embodiment includes a body 200 having a cell trough 212, wherein the sidewall 214 of the cell trough 212 has two hanging holes 206; a cell 202 combined with the cell trough 212, wherein an accommodation area 208 is between the cell 202 and the sidewall 214; and a decorating accessory 204 having a line fixing portion 210, which is through the two hanging holes 206 and the accommodation area 208 so as to let the decorating accessory 204 be fastened at the accommodation area 208.

With reference to FIG. 2B, which illustrates a schematic three-dimensional view of a second preferred embodiment of the present invention. The second preferred embodiment includes a body 200 having a cell trough 212, wherein the sidewall 214 of the cell trough 212 has one hanging hole 206; a cell 202 combined with the cell trough 212, wherein an accommodation area 208 is between the cell 202 and the sidewall 214; and a decorating accessory 204 having an elastic T-type fixing portion 210, which is through the hanging hole 206 and the accommodation area 208 so as to let the decorating accessory 204 be fastened at the accommodation area 208.

The difference between the first preferred embodiment and the second preferred embodiment is that the elastic T-type fixing portion 210 of the second preferred embodiment is made of any elastic material, such as plastic, rubber, etc. The T-type fixing portion 210 has two ends 2101. The two ends 2101 are opened to form a T-shape after the T-type fixing portion 210 is inserted into the hanging hole 206. The two ends 2101 are then urged the sidewall 214 of the cell trough 212, therefore the two ends 2101 are not slid out from the hanging hole 206. That is, the decorating accessory 204 is fastened on the body 200.

With reference to FIG. 2C, which illustrates a schematic three-dimensional view of a third preferred of the present invention. The third preferred embodiment includes a body 200 having a cell trough 212, wherein the sidewall 214 of the cell trough 212 has at least two hanging grooves 206; a cell 202 combined with the cell trough 212, wherein an accommodation area 208 is between the cell 202 and the sidewall 214; and a decorating accessory 204 having a line fixing portion 210, which is through the two hanging grooves 206 and continuously female-connected on the sidewall 214 between the two hanging grooves 206, thus the line fixing portion 210 is fastened at the accommodation area 208.

The difference among the third preferred embodiment, the second preferred embodiment, and the first preferred embodiment is that the body 200 of the third preferred embodiment has the two hanging grooves 206. The line fixing portion 210 of the decorating accessory 204 is female-connected on the two hanging grooves 206 and the sidewall 214 between the two hanging grooves 206, the line fixing portion 210 is fastened at the accommodation area 208 in order to let the decorating accessory 204 be not slid out from the two hanging grooves 206.

Preferably, the portable electronic device is a PDA or a hand-held communication device.

The cell 202 provides power to the portable electronic device and can be a rechargeable battery, such as Lithium battery, Nickel-Metal Hydride battery, Nickel-Cadmium battery, etc.

As a conclusion, the merits of the present invention are as follows:
1. The hanging hole, the hanging holes or the hanging grooves of the present invention are disposed on the sidewall of the cell trough, so that the space for the antenna is not occupied and the signal quality is not affected.
2. Due to above description as the location of the hanging hole, the hanging holes or the hanging grooves, the present invention has the feature of good-looking.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A portable electronic device comprising:
a body having a cell trough, wherein the sidewall of the cell trough has at least one fixing structure for at least one decorating accessory passing through;
a cell combined with the cell trough; and
an accommodation area set between the cell and the sidewall of the cell trough.

2. The portable electronic device according to claim 1, wherein the portable electronic device is a PDA.

3. The portable electronic device according to claim 1, wherein the portable electronic device is a hand-held communication device.

4. The portable electronic device according to claim 1, wherein the at least one fixing structure is defined as two hanging holes, a line fixing portion of the decorating accessory is through the two hanging holes and the accommodation area so as to let the decorating accessory be fastened at the accommodation area.

5. The portable electronic device according to claim 1, wherein the at least one fixing structure is defined as a hanging hole, a T-type fixing portion of the decorating accessory is through the hanging hole so as to fasten the T-type fixing portion at the accommodation area.

6. The portable electronic device according to claim 5, wherein the T-type fixing portion is made of elastic material.

7. The portable electronic device according to claim 1, wherein the at least one fixing structure is defamed as two hanging grooves, a line fixing portion of the decorating accessory is through the two hanging grooves and continuously female-connected on the sidewall between the two hanging grooves, thus the line fixing portion is fastened at the accommodation area.

8. The portable electronic device according to claim 1, wherein the cell is a rechargeable battery.

9. The portable electronic device according to claim 4, wherein the at least one fixing structure is defined as two hanging grooves.

10. The portable electronic device according to claim 5, wherein the at least one fixing structure is defined as one hanging groove.
